(19) United States
(12) Patent Application Publication
(10) Pub. No.: US 2013/0134227 A1
(43) Pub. Date: May 30, 2013

(54) Multi-Layered Flexible Printed Circuit and Method of Manufacture

(71) Applicants: Yannick De Maquille, Saint-Germain-en-Laye (FR); Christophe Mathieu, Mantes la Jolie (FR); Stephane Barlerin, Fatines (FR)

(72) Inventors: Yannick De Maquille, Saint-Germain-en-Laye (FR); Christophe Mathieu, Mantes la Jolie (FR); Stephane Barlerin, Fatines (FR)

(73) Assignee: Linxens Holding, Guyancourt (FR)

(21) Appl. No.: 13/703,394

(22) PCT Filed: Jun. 14, 2011
(86) PCT No.: PCT/EP2011/059817

§ 371 Date: Feb. 5, 2013

(30) Foreign Application Priority Data
Jun. 18, 2010 (IB) PCT/IB2010/001919

(51) Int. Cl. G06K 19/07; H01P 11/00

(52) U.S. Cl. CPC G06K 19/0723; H01P 11/00
USPC 235/492; 29/601

(57) ABSTRACT

A flexible printed circuit includes 2 insulating flexible layers, and 3 conductive layers each including electrical tracks, the conductive and the insulating layers are provided stacked in alternated fashion. Electrical tracks of 3 conductive layers are electrically connected together through respective layers of insulating substrate to form an RFID antenna.

### FIELD OF THE INVENTION

The instant invention relates to multi-layered flexible printed circuits, and their method of manufacture.

### BACKGROUND OF THE INVENTION

Smartcards are now used in every day's life. Some cards are dual interface cards or purely contact-less cards, which can be read by a card reader without any contact. Such cards comprise an integrated circuit (IC) chip which is electrically connected to an RFID antenna. The antenna is used to communicate information between the IC chip and the card reader.

Such antennas can usually be provided either as an electrical wire which is wound and fixed inside the card, or by building a layer of metal on an electrically insulating flexible substrate. This layer can be built by additive technologies such as printing, or substrative technologies such as chemical etching of metallic foils, or even combinations thereof.

One strives to augment the length of the antenna, for example so as to improve the transmission range of the card. However, the dimensions of the overall product should preferably not increase, for cost reasons and should even remain the same, so as to guarantee inter-operability with the other components of the world-wide spread card-reading systems. Further, the pattern of the antenna must be designed with caution, because an ill-designed antenna would be submitted to and/or generate parasite capacitive and/or inductive phenomena between its turns, which would drastically reduce the performance of the card (even with an antenna of augmented length).

WO 2008/081,224 already describes a flexible printed circuit having an antenna comprising tracks provided on both main faces. Although this device performs satisfactorily, one still strives to improve the performances of such products.

### SUMMARY OF THE INVENTION

It is provided a multi-layered flexible printed circuit. The flexible printed circuit comprises at least 2 electrically insulating flexible substrate layers. It further comprises at least 3 electrically conductive layers with each an electrically conductive pattern, which comprise an electrical track.

The electrically conductive layers and the electrically insulating flexible substrate layers are provided stacked in alternated fashion.

The electrical tracks of at least 3 electrically conductive layers are electrically connected together through respective layers of electrically insulating flexible substrate to form an RFID antenna. This antenna has two ends each adapted to be electrically connected to a respective contact of an integrated circuit.

Surprisingly, it was discovered that augmenting the length of the antenna by using additional stacked layers did not substantially degrade the electrical performance of the antenna.

In some embodiments, one might also use one or more of the features defined in the claims.

### BRIEF DESCRIPTION OF THE DRAWINGS

Other characteristics and advantages of the invention will readily appear from the following description of four of its embodiments, provided as a non-limitative example, and of the accompanying drawings.

On the drawings:

FIG. 1 is a perspective exploded view of a smart card according to a first embodiment,

FIG. 2 is a perspective exploded view of a flexible printed circuit for the embodiment of FIG. 1,

FIGS. 3a to 3d are planar views of first, second, third and fourth electrically conductive printed layers, respectively, for the first embodiment,

FIG. 4 is a sectional view along line IV-IV of FIG. 2, of a module comprising the flexible circuit of FIG. 2, according to the first embodiment,

FIG. 5 is a view corresponding to FIG. 2 for a second embodiment,

FIG. 6 is a view corresponding to FIG. 2 for a third embodiment,

FIGS. 7a, 7b, 7c are, respectively, planar views of a first, second and third electrically conductive layers, for a third embodiment, and

FIGS. 8 and 9 are schematic views of a manufacturing apparatus of these embodiments.

On the different Figures, the same reference signs designate like or similar elements.

### DETAILED DESCRIPTION

FIG. 1 schematically shows an example of a smart card 1. According to the present example, the card 1 is provided as an ISO-card having an ISO format. However, the invention could also be applied to other formats of cards, such as SIM cards, memory cards such as micro SD cards, or cards of other formats. A module 2 is received in a cavity formed by a milling process in the card body 3.

As will be described in further details, in the case of a contact card, the module 2 comprises electrical contacts 6 which are accessible to a card-reader. As will be seen later in relation to other embodiments, the card might not be a contact card. Hence, in other embodiments, the module 2 may not comprise contacts 6.

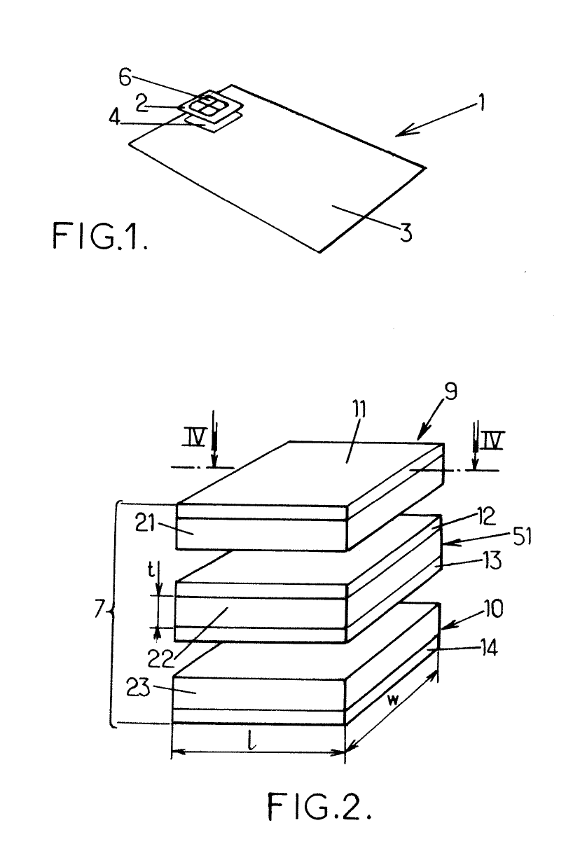

Sticking to the first embodiment, the module 2 consists of an assembly of a multi-layered flexible printed circuit 7, as can be seen on FIG. 2 according to the first embodiment, and of an integrated circuit (IC) chip 8 (not visible on FIG. 2, see FIG. 4). However, according to other embodiments, the module 2 may consist only of the flexible printed circuit 7 itself, whereas the IC chip 8 may not be part of the module 2, but provided elsewhere in the card 1, provided it is electrically connected to the flexible printed circuit in a suitable way.

As can be seen on FIG. 2, the flexible printed circuit 7 is provided as a multi-layered circuit. Electrically insulating flexible substrate layers are stacked in alternated fashion with electrically conductive printed layers.

The first embodiment comprises, from top to bottom, a first electrically conductive layer 11, a first electrically insulating flexible substrate layer 21, a second electrically conductive layer 12, a second electrically insulating flexible layer 22, a third electrically conductive layer 13, a third electrically insulating flexible layer 23 and a fourth electrically conductive layer 14. Suitable materials for the electrically insulating flexible substrate layers include epoxy-glass, PET, PVC, polycarbonate, polyimide, paper, synthetic paper or the like. The dimensions of the electrically insulating flexible substrate layers are a length 1 and a width w suitable to be received in the cavity 4 of the card, such as for example, 13 mm×13 mm. The thickness t of the insulating layers is designed so as to reduce capacitive effect between the two conductive layers provided on each of its sides. It might depend on the constituting material. Preferably, it will be at least 12 μm, such as for example, 75 μm for the case of epoxy-glass. The maximum thickness of the insulating substrate layers will be chosen so that the module 2 can be received and firmly held in the cavity 4 without protruding outside of the card after assembly, and depending on the total number of layers, for example, for a card of 800 μm of thickness, and having a thickness of the bottom of the cavity 4 of 100 μm. In order to enable a roll-to-roll manufacturing process comprising a step of rewinding a band of multi-layered flexible printed circuit, a total thickness of up to 250 μm can be possible for the multi-layered circuit.

Each electrically conductive layer 11-14 is provided as electrically conductive material patterned as will be described in further details below. The electrically conductive material can for example be copper or aluminium or any other suitable material. If necessary, other electrically conductive materials can be provided over the base copper, such as nickel, gold, palladium to provide additional functions, such as corrosion resistance or bondability of the connection wires to the IC chip.

According to an example as shown on FIG. 2, a top flexible printed circuit 9 is provided which comprises the first insulating substrate layer 21 having top and bottom main sides, and the first electrically conductive layer 11 provided on the top main side. Similarly, a bottom flexible printed circuit 10 is provided which comprises the third insulating substrate layer 23 having top and bottom main sides, and the fourth electrically conductive layer 14 provided on its bottom main side. A core flexible printed circuit 51 is provided between the top 9 and the bottom 10 flexible printed circuits. The core flexible printed circuit 51 comprises the second insulating substrate layer 22 having top and bottom main sides, and the second and the third electrically conductive layers 12, 13 provided on each of these main sides. The top 9 and bottom 10 flexible printed circuits are assembled to the core circuit 51 by an electrically insulating adhesive material (typically glue or epoxy-glass pre-preg) forming, respectively, the first and third insulating substrate layers 21, 23.

An RFID antenna 116 (in particular HF antenna) is provided in the flexible printed circuit. The antenna 116 is distributed among the various electrical layers 11-14. The antenna 116 has two ends, which are to be electrically connected to respective contacts of the IC chip 8. The antenna comprises electrical tracks 32, 33, 34 which are provided on the respective electrically conductive layers 12-14 to form a single antenna. Hence, the tracks 32, 33, 34, are electrically connected to one another through the intervening insulating substrate layers. The intervening insulating substrate layers serve to provide electrical insulation between electrical tracks provided onto the neighbour electrically conductive layers, and to reduce the capacity effects between the two.

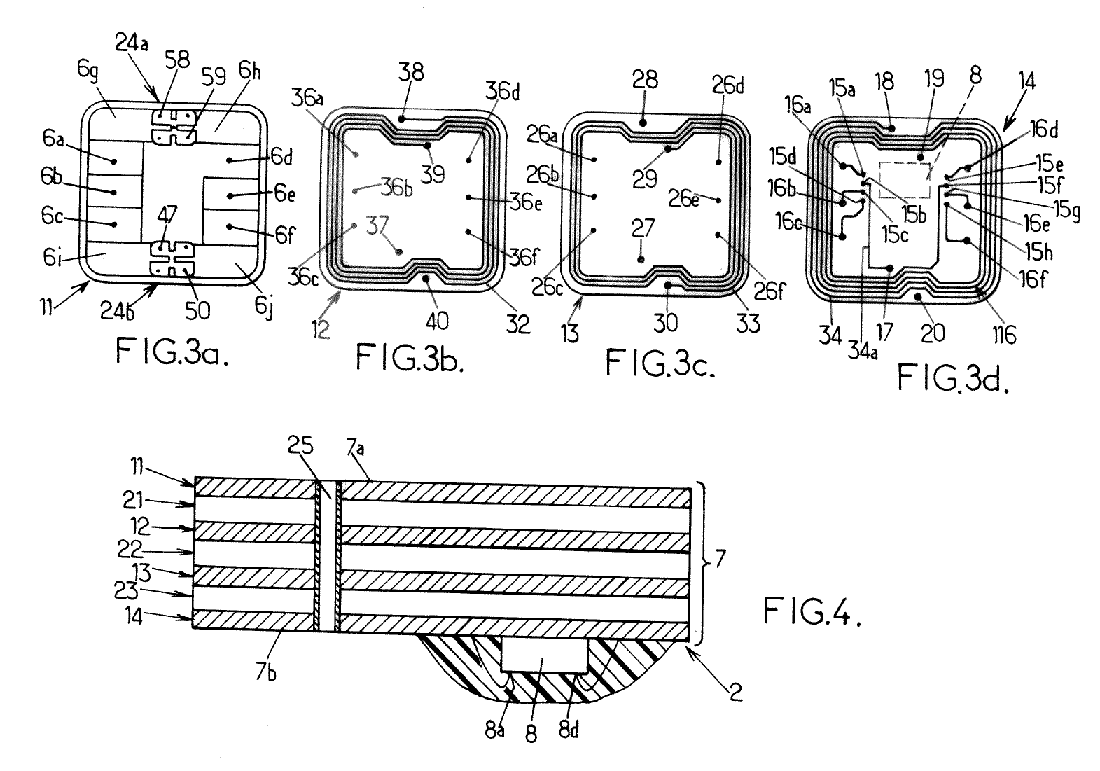

The patterns of each of the electrically conductive layers 11-14 is now described in relation to FIGS. 3a-3d, respectively, for the first embodiment.

Turning to FIG. 3d, the fourth electrically conductive layer 14 comprises eight electrical connection spots 15a-15h disposed and arranged for connection to electrical connection regions of the IC chip (shown in phantom lines on FIG. 3d), for example by gold wire bonding, or flip-chip bonding.

As can be seen on FIG. 3d, the two ends of the antenna are connected to the two electrical connection spots 15b and 15f. The electrical connection spot 15b is connected through a track 34a to a first electrical connection region 17.

The electrical connection spot 15f is connected to the track 34 which performs a plurality of turns up to a second electrical connection region 18. Further, the fourth electrically conductive layer 14 is provided with a third and a fourth electrical connection regions 20, which will be described in more details later.

The third electrically conductive layer 13 is provided with a first electrical connection region 27 superposed to the first electrical connection region 17 of the fourth layer 14, a second electrical connection region 28 superposed with the second electrical connection region 18 of the layer 14, a third electrical connection region 29 superposed to the third electrical connection region 19 of the layer 14, and a fourth electrical connection region 30 superposed to the fourth electrical connection region 20 of the layer 14. Further, a track 33 electrically connects the third and fourth electrically connection regions 29 and 30 to one another through a plurality of turns.

As can be seen on FIG. 3b, the second electrical conductive layer 12 also comprises first, second, third and fourth electrical connection regions 37, 38, 39 and 40 which are superposed, respectively, with the first, 17, 27, the second 18, 28, the third, 19, 29 and the fourth 20, 30 electrical connection regions of the fourth and third electrically conductive layers. Further, the track 32 is provided between the second and third electrical connection regions 38, 39 and has a plurality of turns.

The first electrically conductive layer 11 is provided with electrical contacts 6a-6j, such as the contacts 6a-6f of a six-contact ISO card, as well as six corner contacts 6g, 6j. Further first and second bridge portions 24a, 24b are provided. The bridge portion 24b has a first electrical connection region 47 and a second electrical connection region 50 which are electrically communicating with one another, and which are superposed, respectively, with the first electrical connection regions 17, 27, 37 of the fourth, third, second electrically conductive layers 14, 13, 12, and the fourth electrical connection regions 20, 30, 40 of these layers. The other bridge portion 24a has a first electrical connection region which is superposed with the second electrical connection regions 18, 28, 38 of the fourth, third, second electrically conductive layers 14, 13, 12. It has a second electrical connection region 59 which is superposed with the third electrical connection regions 19, 29, 39 of the fourth, third, second electrically conductive layers 14, 13, 12. Further, the first and second connection regions 58 and 59 are electrically insulated from one another. The contacts 6a-6j and the bridge portions 24a, 24b are all isolated from one another.

Each of the contact 6a, 6f of the first electrically conductive layer 11 is superposed over a respective electrical connection region 36a-36f, 26a-26f, 16a-16f of the second, third and fourth electrically conductive layer 12, 13, 14, respectively. Electrical tracks (not referenced) are used to connect, if necessary, these electrical connection regions 16a-16f with respective ones of the electrical connection spots 15a-15g, in particular those which are not connected to the antenna.

The antenna 116 is therefore a continuous electrical path which is connected between the connection regions 15f and 15b: leaving from the electrical connection spot 15f of the fourth layer 14, the path is followed to the second electrical connection region 18. There, electrical connection is provided through the third insulating substrate layer, through the third electrically conductive layer 13 without contacting the track of the antenna on this layer, through the second insulating substrate layer 22, to the second electrical connection region 38 of the second electrically conductive layer 12. There, the electrical path is provided from the second electrical connection region 38 to the third electrical connection region 39 by the track 32 provided in this layer. The third electrical connection region 39 of the second electrically conductive layer 12 is in electrical connection with the third electrical connection region 29 of the third electrically conductive layer 13 through the second insulating substrate layer 22. The track 33 provided on the third electrically conductive layer 23 provides path for the electricity from the third electrical connection region 29 to the fourth electrical connection region 30 of this layer. The fourth electrical connection region 30 is electrically contacted to the second electrical connection region 50 of the first electrically conductive layer 11 through the second insulating substrate layer 22, the second electrically conductive layer 12 without contacting the track of the antenna on this layer, the first insulating substrate layer. The electrical path continues from the second electrical connection region 50 of the first electrically conductive layer 11 to the first electrically conductive region 47 of this layer. This latter is electrically connected to the first electrical connection region 17 of the fourth electrically conductive layer 14 through the whole flexible printed circuit without contacting any conductive track in between. Finally, the electrical path is provided by the track 34a extending between the first electrical connection region 17 and the electrical connection spot 15b in this electrical layer.

The electrical contacts 6a-6f are also provided in electrical communication with the respective electrical connection regions 16a-16f of the fourth electrically conductive layer 14 through the whole flexible printed circuit, without electrical contact with the tracks of the antenna disposed in the intervening layers.

Although the bridge portion 24b of the first electrical layer is provided as a bridge over the antenna, one is not limited to using this layer to provide such electrical connection. It could alternately be provided by any other suitable way, such as by a strap, for example.

As can be seen by the above description, the length of the antenna has been considerably increased in a surface of the flexible printed circuit which is limited to the surface area of the electrical contacts, allowing for instance high inductance value of the HF antenna despite reduced area.

FIG. 4 now shows a cross sectional view of the flexible printed circuit 7 with a chip 8 fixed thereto. This view is schematic and it should be understood that each of the electrically conductive layers 11-14 in reality are not plane continuous layers, as shown, but have in cross section, a plurality of spaced apart regions, according to the pattern of each layer. Two electrical contacts 8a, 8d of the chip are shown electrically connected to the layer 14 (of course, the two corresponding connection regions of the layer 14 are insulated from one another, as explained above).

A number of plated through holes 25 extend through the flexible circuit 7. These plated through holes 25 each correspond to one of the electrical connection regions 17-20 and 16a-16f of the fourth electrically conductive layer 14. They are provided from the bottom face 7b of the flexible printed circuit to the top face 7a. For example, the hole 25 which is illustrated could correspond to one of the electrical connection regions 16a-16f, and extend all the way to the corresponding electrical contacts of the first layer 11. The holes 25 corresponding to the first and fourth electrical connection regions 17 and 20 will also extend according to this same depth, for electrical connection to the bridge 24b. The holes corresponding to the regions 18 and 19 extend to the bridge portion 24a, but are not shorted since the regions 58 and 59 are insulated from one another.

Alternatively, other electrical connection means than plated through holes could be used to electrically connect together electrical tracks of two or more layers separated by at least one layer of insulating material.

The pattern which has been described in relation to FIGS. 3a-3d is illustrative only.

FIG. 5 now shows a second embodiment of a flexible printed circuit 7 according to the invention. According to this embodiment, compared to the first embodiment, the core flexible printed circuit 51 has been removed. This flexible printed circuit can be provided as the assembly of a top 9 and of a bottom 10 flexible printed circuits. The top flexible printed circuit can for example comprise the assembly of the first 11 and second 12 electrically conductive layers on the second insulating substrate layer 21. The bottom printed circuit 10 can for example comprise the third insulating substrate layer 23 carrying the third and fourth electrically conductive layers 13 and 14. These two circuits can be assembled by any suitable means, such as for example using an electrically insulating adhesive material (typically glue or epoxy-glass pre-preg) forming the second insulating layer 22.

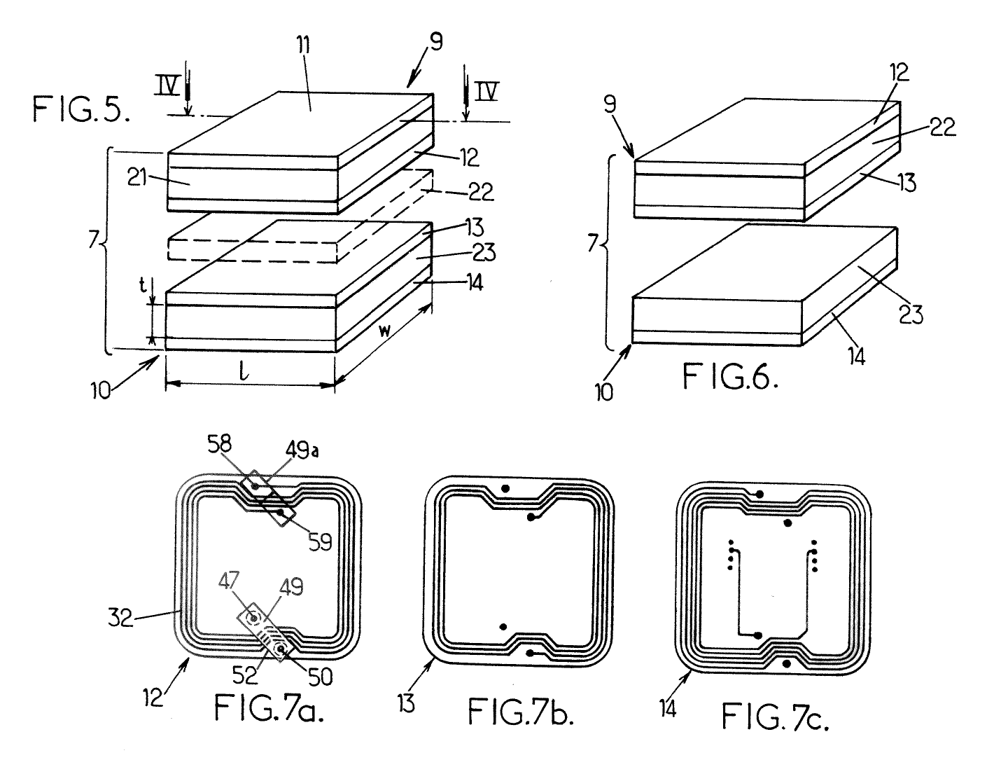

FIG. 6 now shows a third embodiment of a flexible printed circuit 7 according to the invention. According to this embodiment, compared to the second embodiment, the first electrically conductive layer 11 and the first insulating substrate layer 21 have been removed. This flexible printed circuit can still be provided as the assembly of the top 9 and the bottom 10 flexible printed circuits. The top flexible printed circuit can for example comprise the assembly of the second electrically conductive layer 12, the second insulating substrate layer 22 and the third electrically conductive layer 13. The bottom printed circuit 10 can for example comprise the assembly of the third insulating substrate layer 23 and of the fourth electrically conductive layer 14. These two circuits can be assembled by any suitable means, such as for example using a not shown electrically insulating adhesive material (typically glue or epoxy-glass pre-preg).

According to this third embodiment, the flexible printed circuit 7 is not provided with any contact. It is therefore provided as a purely contactless card. As can be seen on FIGS. 7a-7c, the electrical patterns provided for each layer can be the same as these for the first embodiment. The main difference is that the electrical connection regions 16a-16f to the contacts are removed, as well as the electrical tracks connecting these regions with the corresponding electrical connection spots to the chip. As mentioned above, the bridge portion 24b could be replaced by any suitable means, such as a strap 49b having two connection portions 47, 50 carried by an insulating substrate 52 which overlies the track 32 of the layer 12. A similar strap 49a replaces the bridge portion 24a with, however the electrical regions 58, 59 insulated from one another.

According to yet another embodiment, not shown, the first insulating substrate layer 21 could be added so as to protect the top most electrically conductive layer 12, if necessary. In such case, for example, the top and bottom flexible printed circuits 9, 10 could be provided as shown on FIG. 5, without the first electrically conductive layer 11.

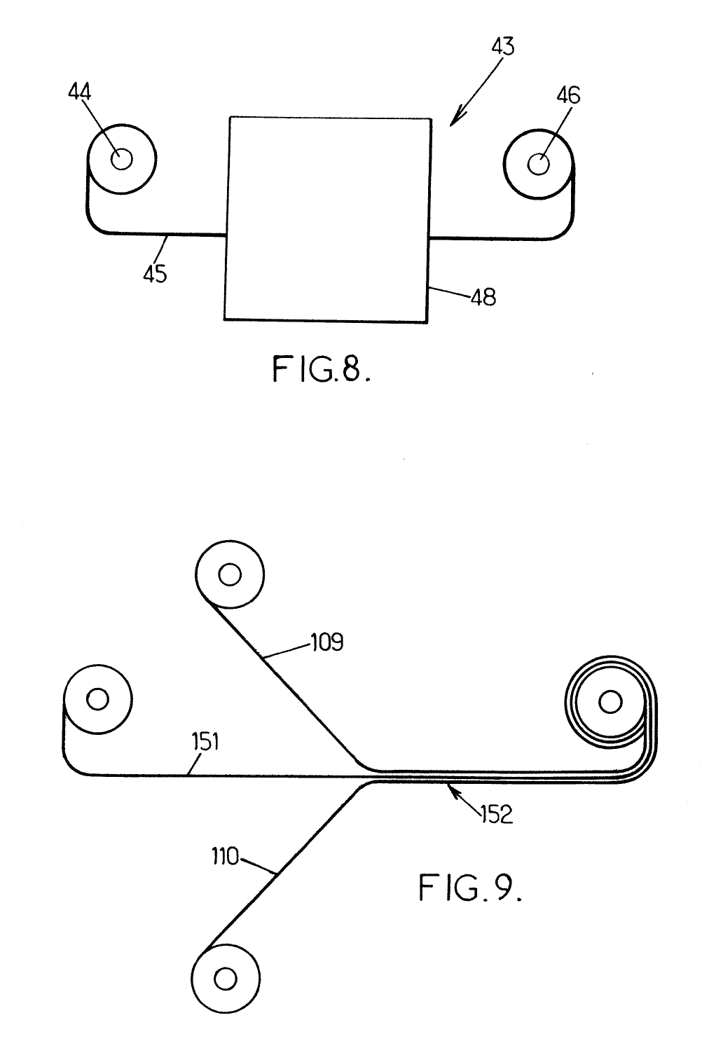

Any of the above described embodiments could be manufactured using continuous reel-to-reel processes. As schematically shown on FIG. 8, a manufacturing apparatus 43 can be provided which comprises an unwinding station 44 of flexible material 45, and a rewinding station 46 which rewinds the flexible material 45 provided from the unwinding station 44 after handling by a handling cell 48. A plurality of such apparatus can be provided, with different handling cells 48, which each continuously perform different steps of the process. For example, the flexible substrate 45 is an assembly of an electrically insulating substrate and one metal foil on one or each of its main faces, which is passed through a photo-exposure process in the handling cells 48, followed by a chemical-etching process so as to provide the suitable patterns. For example, the core layer 51 of the first embodiment is manufactured this way.

As shown on FIG. 9, the band 151 which is to provide the core circuit 51 can be precisely assembled to a top band 109 and a bottom band 110, simultaneously, or one after the other, by using suitable insulating adhesive material (typically glue or epoxy-glass pre-preg). The top and bottom bands are formed as assemblies of insulating material and unpatterned external metal. The assembly is performed preferably with a precision of about 75 μm or less (machine- and transverse direction).

The band 152 formed as the assembly of the bands 109, 151 and 110 is rewound. Then, plated through holes are formed in the suitable locations, so as to electrically connect together the electrical tracks provided on the layers. This band 152 can then be handled in a similar photo-exposure process followed by a chemical etching process so as to provide a suitable pattern on the external metallic faces. Other possible handling cells include electro-plating cells so as to deposit gold to the contacts, for example.

The band can then be separated into individual multi-layered flexible printed circuits.

Although some embodiments above are related to a dual interface card, i.e. having contacts and antenna connected to the same chip, it could also be provided a hybrid card according to the invention, where the antenna is connected to one chip, and the contacts to another chip.

1. A flexible printed circuit comprising at least 2 electrically insulating flexible substrate layers, and at least 3 electrically conductive layers each with an electrically conductive pattern comprising an electrical track,
wherein the electrically conductive layers and the electrically insulating flexible substrate layers are provided stacked in alternated fashion,
wherein electrical tracks of at least 3 electrically conductive layers are electrically connected together through respective layers of electrically insulating flexible substrate to form a RFID antenna having two ends, each adapted to be electrically connected to a respective contact of an integrated circuit.

2. Flexible printed circuit according to claim 1, further comprising a third electrically insulating flexible substrate layer stacked over one electrically conductive layer.

3. Flexible printed circuit t according to claim 2, further comprising a fourth electrically conductive layer stacked over said third electrically insulating flexible substrate layer.

4. Flexible printed circuit according to claim 1, wherein an external electrically conductive layer comprises electrical contacts adapted to be electrically contacted by an external card reader, some of said electrical contacts also being adapted to be electrically connected to a respective contact of an integrated circuit.

5. Flexible printed circuit according to claim 4 wherein said electrical contacts are adapted to be electrically connected to a respective contact of an integrated circuit through at least one of said layers of electrically insulating flexible substrate.

6. Flexible printed circuit according to claim 1, wherein at least one of said electrically insulating flexible substrate layers is a double-sided layer having two opposite main sides, wherein 2 of said electrically conductive layers are patterned on a respective one of said main sides, and wherein one track of one of said 2 electrically conductive layers is electrically connected to one track of the other of said 2 electrically conductive layers through a metalized through hole provided in said double-sided layer.

7. Flexible printed circuit according to claim 1, wherein at least one intermediate electrically conductive layer is located between two remote electrically conductive layers, and further comprising an electrical connection adapted to electrically connect to one another one track of each of said two remote electrically conductive layers through at least two intervening electrically insulating flexible substrate layers and through said intermediate electrically conductive layer without electrically contacting any track of said intermediate electrically conductive layer.

8. Flexible printed circuit according to claim 1 wherein at least one of said electrically insulating flexible substrate layers is made from at least one of epoxy-glass, PET, PVC, polycarbonate, polyimide, paper or synthetic paper.

9. Flexible printed circuit according to claim 1, wherein at least one, and preferably all electrically insulating flexible substrate layers has a thickness of at least 12 micrometers (ym) and/or wherein the thickness of the whole flexible printed circuit is at most 250 ym.

10. A module comprising a flexible printed circuit according to claim 1, and an integrated circuit having at least two contacts each connected to a respective end of said antenna.

11. A flexible card comprising a module according to claim 10.

12. A method of manufacturing a multi-layered flexible printed circuit comprising:
a) providing at least 2 electrically insulating flexible substrate layers, and at least 3 electrically conductive layers each with an electrically conductive pattern comprising an electrical track,
b) stacking in alternated fashion the electrically conductive layers and the electrically insulating flexible substrate layers,
c) electrically connecting together electrical tracks (31-34) of at least 3 electrically conductive layers through respective layers of electrically insulating flexible substrate to form an RFID antenna having two ends each adapted to be electrically connected to a respective contact of an integrated circuit.

13. Method according to claim 12, wherein a) providing comprises providing electrically insulating flexible substrate layers, carrying respective electrically conductive layers.

14. Method according to claim 13, wherein a) providing comprises manufacturing electrically insulating flexible substrate layers carrying respective electrically conductive layers in a continuous roll-to-roll process.

15. Method according to claim 12, wherein b) stacking comprises adhering flexible printed circuits to one another.

16. Method according to claim 12, wherein c) electrically connecting comprises electrically connecting 2 electrically conductive layers carried on opposite main sides of an electrically insulating flexible substrate layer through said electrically insulating flexible substrate layer by a metalized through hole.
